(19) United States
(12) Patent Application Publication
(10) Pub. No.: US 2006/0282310 A1
(43) Pub. Date: Dec. 14, 2006

(54) System and method for providing discounts to members at participating merchants and commissions to referring entity

(76) Inventor: Michael J. Burch, Odon, IN (US)

Correspondence Address: WOODARD, EMHARDT, MORIARTY, MCNETT & HENRY LLP, 111 MONUMENT CIRCLE, SUITE 3700, INDIANAPOLIS, IN, 46204-5137, US

(21) Appl. No.: 11/147,934

(22) Filed: Jun. 8, 2005

(51) Int. Cl. G06Q 30/00

(52) U.S. Cl. 705/14

(57) ABSTRACT

A computer system and method includes a discount program and a referral program. A sponsor, such as a credit union, enters into arrangements with merchants to offer a discount program to members. The member receives an instant discount off the purchase at a participating merchant. The sponsor receives a referral fee from the merchant. The referral fee is debited from the merchant account and credited to the sponsor account using an automated clearinghouse. The referral fee is paid to the sponsor in near real-time or later. The member benefits by receiving a discount, and in the case of a credit union being the sponsor, the member also benefits because the credit union received the referral fee. The sponsor benefits by receiving the referral fee and by improved member services. Although the merchant funds the discount amount and the referral fee, the merchant benefits from having new or repeat customers.

### BACKGROUND OF THE INVENTION

The present invention relates to computer systems and more particularly, but not exclusively, to computer systems for managing member reward programs.

There are various types of member reward programs available today. Some reward programs provide a discount to the member at participating merchant locations. In such programs, a sponsor may have contracts with various merchants that agree to provide a certain discount when presented with a valid membership card for the program. Others reward programs are designed to reward the referring party with a referral fee when a new customer buys products or services from a particular merchant based on the referral from the referring party. These programs suffer from various limitations, including extensive paper handling, time delays to receive the discount and/or referral fee, etc. Accordingly, there exists a need for an improved rewards program that offers additional rewards with better automation. The current invention is directed to meeting these and other needs.

### SUMMARY OF THE INVENTION

One form of the present invention incorporates a computer system. Other forms include unique systems and methods for providing rewards programs.

In one aspect of the invention, a system and method is disclosed that includes a discount program and a referral program. A sponsor, such as a credit union, enters into arrangements with one or more merchants to offer a discount program to the member. The member receives an instant discount off purchases when using the discount program at a participating merchant. After the member pays for the purchase at the discounted price, the sponsor receives a referral fee from the merchant. The referral fee is debited from the merchant account and credited to the sponsor account using an automated clearinghouse. The referral fee can be paid to the credit union in near real-time from when the purchase is completed, or the referral fee can be paid at a later time, such as on a bulk basis. The member benefits by receiving a discount on the purchase price, and in the case of a credit union being the sponsor, the member also benefits because the credit union received the referral fee. The sponsor benefits by receiving the referral fee and by improving services to its members. Although the merchant funds both the discount amount and the referral fee, the merchant still benefits from having a new or repeat customer.

Yet other forms, embodiments, objects, advantages, benefits, features, and aspects of the present invention will become apparent from the detailed description and drawings contained herein.

### BRIEF DESCRIPTION OF THE DRAWINGS

FIG. 1 is a diagrammatic view of a computer system illustrating one embodiment of the present invention.

FIG. 2 is a data flow diagram for the system of FIG. 1 demonstrating the flow of data in a discount and referral program.

FIGS. 3A-3B are a process flow diagram for the system of FIG. 1 demonstrating the stages involved in providing discounts to members at participating merchants and referral fees to sponsors.

### DETAILED DESCRIPTION

For the purposes of promoting an understanding of the principles of the invention, reference will now be made to the embodiments illustrated in the drawings and specific language will be used to describe the same. It will nevertheless be understood that no limitation of the scope of the invention is thereby intended. Any alterations and further modifications in the described embodiments, and any further applications of the principles of the invention as described herein are contemplated as would normally occur to one skilled in the art to which the invention relates.

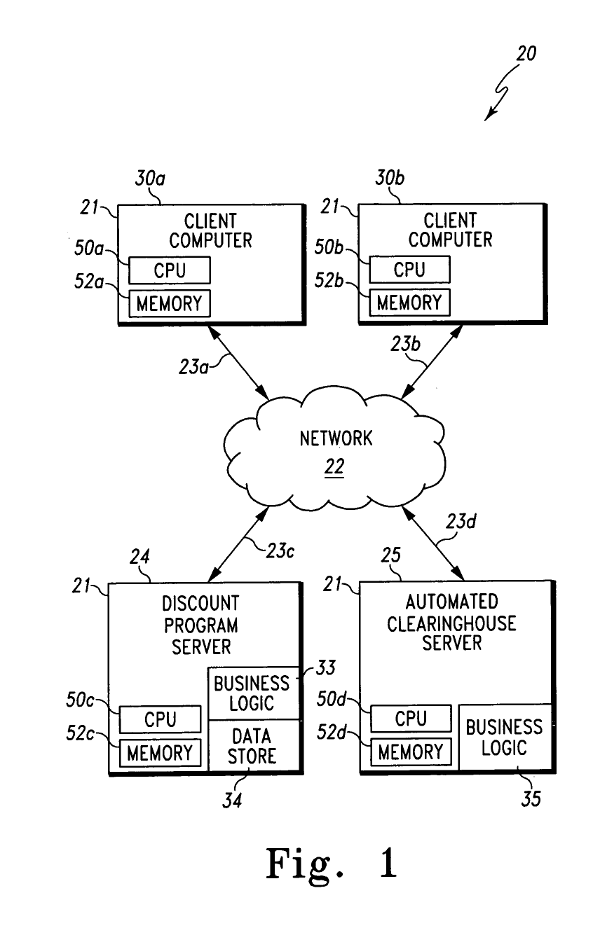

FIG. 1 is a diagrammatic view of computer system 20 of one embodiment of the present invention. Computer system 20 includes computer network 22. Computer network 22 couples together a number of computers 21 over network pathways 23a-d. System 20 includes multiple servers, such as Discount Program Server 24 and Automated Clearinghouse Server 25. System 20 also includes representative client computers 30a and 30b. While computers 21 are each illustrated as being a server or client, it should be understood that any of computers 21 may be arranged to include both a client and server. Furthermore, it should be understood that while four computers 21 are illustrated, more or fewer may be utilized in alternative embodiments.

Computers 21 include one or more processors or CPUs (50a, 50b, 50c, and 50d, respectively) and one or more types of memory (52a, 52b, 52c, and 52d, respectively). Although not shown to preserve clarity, each memory 52a, 52b, 52c, and 52d illustratively includes a removable memory device. Each processor may be comprised of one or more components configured as a single unit. Alternatively, when of a multi-component form, a processor may have one or more components located remotely relative to the others. One or more components of each processor may be of the electronic variety defining digital circuitry, analog circuitry, or both. In one embodiment, each processor is of a conventional, integrated circuit microprocessor arrangement, such as one or more PENTIUM III or PENTIUM 4 processors supplied by INTEL Corporation of 2200 Mission College Boulevard, Santa Clara, Calif. 95052, USA.

Each memory (removable or fixed) is one form of computer-readable device. Each memory may include one or more types of solid-state electronic memory, magnetic memory, or optical memory, just to name a few. By way of non-limiting example, each memory may include solid-state electronic Random Access Memory (RAM), Sequentially Accessible Memory (SAM) (such as the First-In, First-Out (FIFO) variety or the Last-In-First-Out (LIFO) variety), Programmable Read Only Memory (PROM), Electronically Programmable Read Only Memory (EPROM), or Electrically Erasable Programmable Read Only Memory (EEPROM); an optical disc memory (such as a DVD or CD ROM); a magnetically encoded hard disc, floppy disc, tape, or cartridge media; or a combination of any of these memory types. Also, each memory may be volatile, nonvolatile, or a hybrid combination of volatile and nonvolatile varieties.

Although not shown to preserve clarity, in one embodiment each computer 21 is coupled to a display. Computers may be of the same type, or a heterogeneous combination of different computing devices. Likewise, displays may be of the same type, or a heterogeneous combination of different visual devices. Although again not shown to preserve clarity, each computer 21 may also include one or more operator input devices such as a keyboard, mouse, track ball, light pen, and/or microtelecommunicator, to name just a few representative examples. Also, besides a display, one or more other output devices may be included such as loudspeaker(s) and/or a printer. Various display and input device arrangements are possible.

Computer network 22 can be in the form of a Local Area Network (LAN), Municipal Area Network (MAN), Wide Area Network (WAN), such as the Internet, a combination of these, or such other network arrangement as would occur to those skilled in the art. The operating logic of system 20 can be embodied in signals transmitted over network 22, in programming instructions, dedicated hardware, or a combination of these. It should be understood that more or fewer computers 21 can be coupled together by computer network 22.

In one embodiment, system 20 operates at one or more physical locations to provide a discount and referral system. In one embodiment, Discount Program Server 24 is configured to host business logic 33 and data store 34 for managing the discount and referral program information, and Automated Clearinghouse Server 25 is configured to host business logic 35 for managing the referral fee financial transfers between merchants and sponsors. The two processes are operable to communicate with one another over network 22. In one embodiment, client computers 30a-30b are configured for allowing a user to access business logic 33 and/or data store 34 of Discount Program Server 24, and/or business logic 35 of Clearinghouse Server 25. As a few non-limiting examples, client computers 30a-30b could be used by a checkout clerk at a point-of-sale merchant terminal to verify discount program membership and/or calculate discounts on purchases, client computers 30a-30b could be used by a member to visit a participating merchant on-line web site to make discounted purchases under the discount program, and/or client computers 30a-30b could be used by a discount program administrator or other designated party to administer the discount program. One of ordinary skill in the software art will appreciate that user interfaces on client computers 30a-30b, discount program business logic 33, data store 34, and clearinghouse server business logic 35 can be hosted on one or more computers in a thin client or thick client architecture and still be within the spirit of the invention. In one embodiment, Discount Program Server 24 is located in a different physical location than Automated Clearinghouse Server 25. In another embodiment, Discount Program Server 24 is located in the same physical location as Automated Clearinghouse Server 25. In one embodiment, Discount Program Server 24 is under the control of a discount program administrator or designated representative, and Automated Clearinghouse Server 25 is under the control of an automated clearinghouse administrator or designated representative. Other variations are also possible, as would occur to one of skill in the art.

Typical applications of system 20 would include more or fewer client computers of this type at one or more physical locations, but only two have been illustrated in FIG. 1 to preserve clarity. Furthermore, although only two servers are shown, it will be appreciated by those of ordinary skill in the art that the one or more features provided by Discount Program Server 24 and Automated Clearinghouse Server 25 could be provided on the same computer or varying other arrangements of computers at one or more physical locations and still be within the spirit of the invention. Farms of dedicated servers could also be provided to support the specific features if desired.

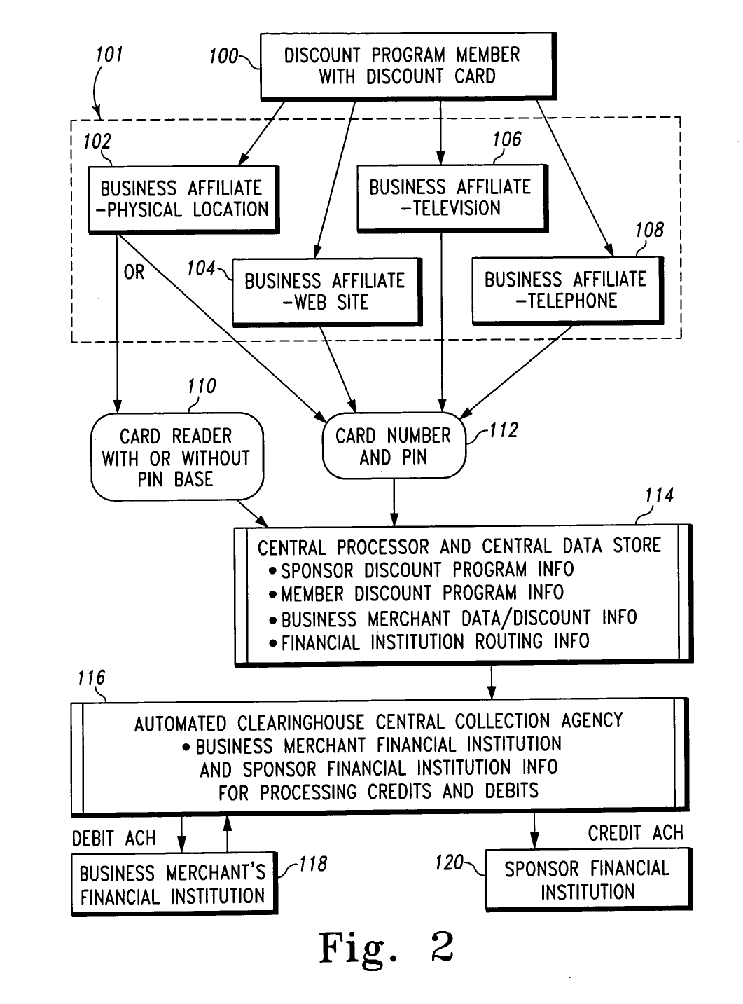

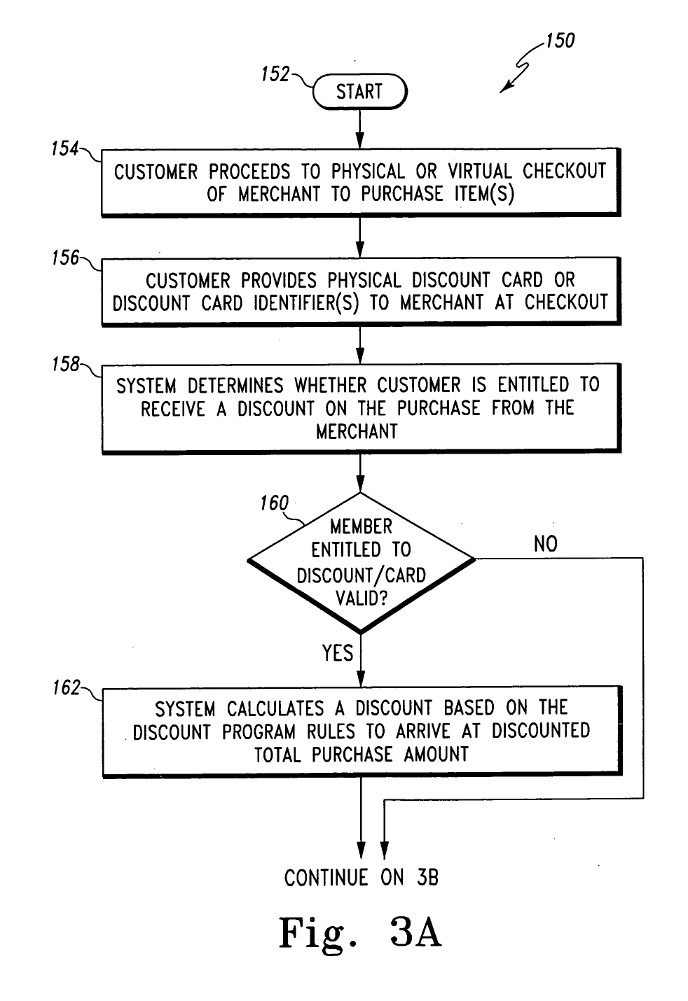

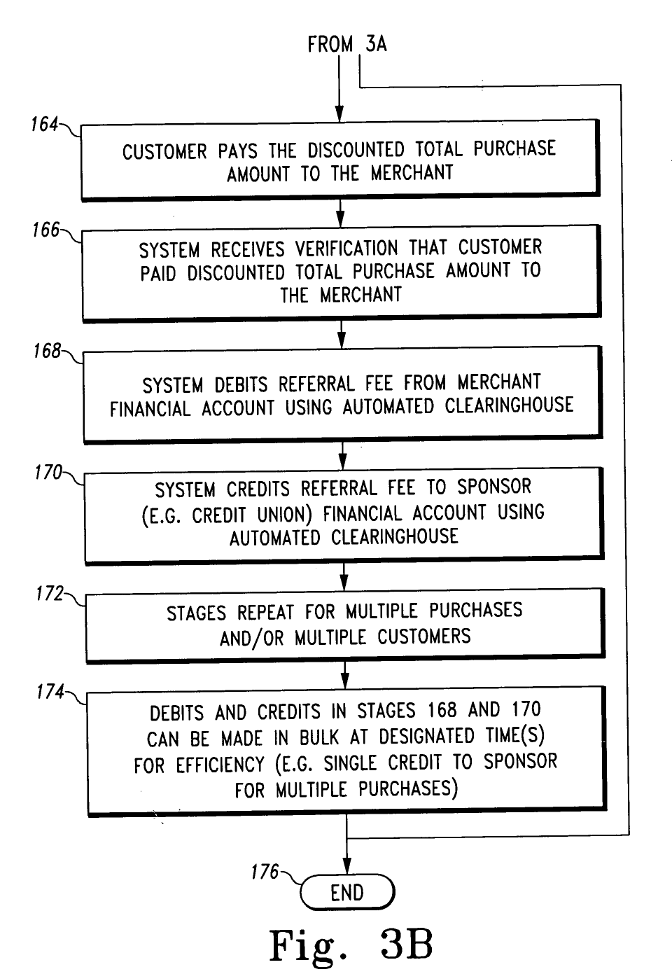

Referring additionally to FIG. 2, a data flow diagram illustrates the high level flow of data in the discount and referral program of system 20. The details of the stages involved in these processes will also be described in greater detail with respect to FIGS. 3A-3B. By way of some non-limiting examples, a discount program member 100 can use a discount card with a business merchant 101 at a physical location 102, on a business merchant web site 104, with a business merchant by television 106, and/or with a business merchant by telephone 108. If the discount program member 100 uses the discount card at a physical merchant location 102, then a discount card reader with or without a pin base 110 can be used to read the discount card, or a card number and PIN 112 can be provided to the merchant without using a discount card reader. When ordering from a merchant web site 104, from a merchant by television 106, or from a merchant by telephone 108, a card number and PIN 112 can be provided to the merchant.

Upon providing the discount identifier(s) to the merchant, a central processor and central data store 114 can be used to determine whether a member 100 has a valid discount card and what type of discount can be provided to the member by this merchant. In one embodiment, business logic 33 of Discount Program Server 24 functions as the central processor element, and data store 34 of Discount Program Server 24 functions as the central data store element of processor or data store 114. Sponsor discount program information, member discount program information, business merchant data and discount information, and/or financial insitution routing information can also be stored in the central data store, for example. A few non-limiting examples of sponsor discount information include the sponsor name and address. Examples of member discount program information include member name, address, member identifier(s), to name a few non-limiting examples. Business merchant data and discount information can include merchant name, address, and/or discount program rules, to name a few examples. Examples of financial institution routing information can include routing information for the financial institution of the merchant and/or the discount program sponsor.

The central processor and central data store 114 is able to communicate with an automated clearinghouse central collection agency 116 to manage the payment of referral fees. In one embodiment, Automated Clearinghouse Server 25 performs the function of automated clearinghouse central collection agency 116. Automated clearinghouse central collection agency 116 is responsible for storing and/or managing merchant and financial institution information for processing debits and credits for the referral fees. For example, automated clearinghouse central collection agency 116 debits the financial institution account 118 of merchant 101 in the amount of the referral fee and then issues a credit to the financial institution account 120 of a sponsor for the referral fee. These processes will now be described in greater detail in FIGS. 3A-3B.

Referring additionally to FIGS. 3A-3B, procedure 150 demonstrates the stages involved in providing discounts to members at participating merchants and referral fees to sponsors. In one form, procedure 150 is at least partially implemented in the operating logic of system 20. Procedure 150 begins on FIG. 3A at start point 152 with the customer (discount card member) proceeding to the physical or virtual checkout of the merchant to purchase one or more items (stage 154). The customer provides the physical discount card and/or discount card identifier(s) to the merchant at checkout (stage 156). In an illustrative example, Discount Program Server 24 determines whether the customer is entitled to receive a discount on the purchase from the merchant (stage 158). If the card is not valid and/or the customer is not entitled to a discount (decision point 160), then the process ends at end point 176. If the card is valid and the customer is entitled to a discount (decision point 160), then Discount Program Server 24 calculates a discount based on the discount program rules to arrive at a discounted total purchase amount (stage 162).

Continuing now with FIG. 3B, the customer pays the discounted total purchase amount to the merchant (stage 164) using cash, a credit card, or other suitable payment method. Discount Program Server 24 receives verification that the customer paid the discounted total purchase amount to the merchant (stage 166) and stores information about the transaction, such as total purchase amount, in the data store 34. In an illustrative example, Automated Clearinghouse Server 25 debits the referral fee from merchant financial account using an automated clearinghouse (stage 168). Automated Clearinghouse Server 25 credits the referral fee to the sponsor's (e.g. credit union's) financial account using an automated clearinghouse (stage 170). An automated clearinghouse allows electronic transfers and payments to be made between various financial institutions without the use of paper checks. In one embodiment, the sponsor of the discount program is a credit union. Banks or other organizations could also be sponsors of the discount program in other embodiments.

The stages of FIGS. 3A-3B can be repeated for multiple purchases and/or multiple customers (stage 172). In one embodiment, the debit and credit steps are performed in near real-time after the purchase has been completed to provide prompt payment to the sponsor for the referral fee. In another embodiment, the debits and credits can be made in bulk at designated time(s) for efficiency (stage 174). As one non-limiting example, a single credit can be made after a designated time period to a particular sponsor's financial account for referral fees earned from multiple purchases by multiple customers at one or more participating merchants. Other bulk debit and/or credit variations are also possible. The process then ends at end point 176.

By using system 20, the customer member of the discount program benefits by receiving a discount on the purchase price, and in the case of a credit union being the sponsor, the member also benefits because the credit union receives the referral fee. Since credit unions are owned and operated by their members, the referral fee paid to the credit union financially benefits each member in some fashion. The sponsor benefits from system 20 because it receives the referral fee and is also able to improve services to members through the discount incentives. Although the merchant funds both the discount amount and the referral fee, the merchant still benefits from using system 20 by having a new or repeat customer.

In one embodiment of the present invention, a method is disclosed that comprises the steps of receiving at least one discount card identifier associated with a customer making a purchase from a merchant, verifying in a database that the identifier associates the customer with a discount program that entitles the customer to a discount on the purchase from the merchant, receiving verification that a payment for a discounted purchase total was provided by the customer as payment for the purchase, debiting a referral fee from a financial account associated with the merchant using an automated clearinghouse, and crediting the referral fee to a fianancial account of a sponsor of the discount program using the automated clearinghouse.

In another embodiment of the present invention, a system is disclosed that comprises a first server that verifies that a discount card identifier is associated with a discount program and entitles a customer to a discount on a purchase at a participating merchant, and receives verification that a payment for a discounted purchase total was provided by the customer. A second server is coupled to the first server over a network and uses an automated clearinghouse to debit a referral fee from an account associated with the participating merchant and credit the referral fee to an account of a sponsor of the discount program.

In yet another embodiment of the present invention, an apparatus is disclosed that comprises a device encoded with logic executable by one or more processors to verify in a database that a discount card identifier provided by a customer associates the customer with a discount program that entitles the customer to a discount on a purchase from a merchant, receive verification that a payment for a discounted purchase total was provided by the customer as payment for the purchase, debit a referral fee from a financial account associated with the merchant using an automated clearinghouse, and credit the referral fee to a financial account of a sponsor of the discount program using the automated clearinghouse.

One of ordinary skill in the art will appreciate that while the term discount card is used in the examples herein for purposes of illustration, other types of instruments and/or identifiers that evidence membership in a program could also be used with the system and methods discussed herein and still be in the spirit of the invention. As one non-limiting example, biometric data (fingerprint, etc.) could be used to identify and verify that the individual is a member of the particular discount program.

One of ordinary skill in the computer software art will also appreciate that the functionality, processes, and/or components described herein can be separated or combined on one or more computers or screens in various arrangements and still be within the spirit of the invention.

While the invention has been illustrated and described in detail in the drawings and foregoing description, the same is to be considered as illustrative and not restrictive in character, it being understood that only the preferred embodiment has been shown and described and that all equivalents, changes, and modifications that come within the spirit of the inventions as described herein and/or by the following claims are desired to be protected.

What is claimed is:

1. A method comprising:
receiving at least one discount card identifier, said identifier being associated with a customer making a purchase from a merchant;
verifying in a database that the identifier associates the customer with a discount program that entitles the customer to a discount on the purchase from the merchant;
receiving verification that a payment for a discounted purchase total was provided by the customer as payment for the purchase;
debiting a referral fee from a financial account associated with the merchant using an automated clearinghouse; and
crediting the referral fee to a fianancial account of a sponsor of the discount program using the automated clearinghouse.

2. The method of claim 1, wherein the sponsor of the discount program is a credit union.

3. The method of claim 2, wherein the customer is a member of the credit union and wherein the member benefits from the discount program by receiving discounts on purchases and also from the credit union receiving the referral fee.

4. The method of claim 1, wherein the identifier includes a card number and a personal identification number.

5. The method of claim 4, wherein the customer is making the purchase by telephone.

6. The method of claim 4, wherein the customer is making the purchase electronically.

7. The method of claim 1, wherein the identifier is received by reading a magnetic strip on a discount card provided by the customer to the merchant.

8. The method of claim 1, wherein the debiting and crediting steps are performed in near real-time after the receiving verification step.

9. The method of claim 1, wherein the debiting and crediting steps are performed for the purchase at a designated time in a bulk fashion along with a plurality of other purchases.

10. The method of claim 9, wherein the crediting step includes issuing a single credit to the financial account of the sponsor for a plurality of referral fees related to the discount program of the sponsor.

11. The method of claim 1, further comprising:
prior to the receiving verification step, calculating a discount amount for the purchase to determine the discounted purchase total.

12. A system comprising:
a first server, said first server being operable to:
verify that a discount card identifier is associated with a discount program and entitles a customer to a discount on a purchase at a participating merchant, and receive verification that a payment for a discounted purchase total was provided by the customer; and
a second server, said second server being coupled to the first server over a network, said second server being operable to use an automated clearinghouse to debit a referral fee from an account associated with the participating merchant and credit the referral fee to an account of a sponsor of the discount program.

13. The system of claim 12, wherein the first server and the second server are the same server.

14. The system of claim 12, wherein the first server is operable to calculate a discount amount for the purchase to determine the discounted purchase total.

15. The system of claim 12, wherein the second server is operable to perform the debit and credit in near real-time after receiving confirmation from the first server that the payment was provided by the customer.

16. The system of claim 12, wherein the second server is operable to perform the debit and credit in a bulk fashion along with a set of debit and credits for a plurality of other purchases.

17. The system of claim 16, wherein the second server is operable to issue a single credit to the account of the sponsor for a plurality of referral fees related to the discount program of the sponsor.

18. An apparatus comprising:
a device encoded with logic executable by one or more processors to:
verify in a database that a discount card identifier provided by a customer associates the customer with a discount program that entitles the customer to a discount on a purchase from a merchant;
receive verification that a payment for a discounted purchase total was provided by the customer as payment for the purchase;
debit a referral fee from a financial account associated with the merchant using an automated clearinghouse; and
credit the referral fee to a financial account of a sponsor of the discount program using the automated clearinghouse.

19. The apparatus of claim 18, wherein the device includes a removable memory device carrying a number of processor executable instructions to define the logic.

20. The apparatus of claim 19, wherein the removable memory device includes a disk.
